(19) United States
(12) Patent Application Publication
(10) Pub. No.: US 2025/0246614 A1
(43) Pub. Date: Jul. 31, 2025

(54) Rechargeable All-Water Atomic Battery

(71) Applicant: Jerome J. Cuomo, Cary, NC (US)

(72) Inventor: Jerome J. Cuomo, Cary, NC (US)

(21) Appl. No.: 19/184,004

(22) Filed: Apr. 21, 2025

(51) Int. Cl. H01M 4/38; H01M 10/38

(52) U.S. Cl. CPC H01M 4/383; H01M 10/38

(57) ABSTRACT

A rechargeable electrochemical system is disclosed that operates using ultra-pure water and a preconditioned electrode without added salts, acids, bases, or catalysts. The electrode is infused with reactive hydrogen species, such as atomic hydrogen, through methods including electrolysis, thermal exposure, or ambient-compatible water jet impact. Upon immersion in ultra-pure water and pairing with a second electrode, the infused electrode induces a spontaneous electrochemical potential. The water, initially non-conductive, becomes weakly alkaline and functions as an electrolyte. The system generates measurable voltage and current under ambient conditions. After discharge, the infused electrode can be restored by reapplying the hydrogen-infusion process or an external potential, enabling repeated charge-discharge cycles. Experimental validation shows consistent electrochemical behavior and power output sufficient for common electronic components. This system offers a scalable, environmentally compatible alternative to conventional batteries and hydrogen energy systems, enabling novel electrochemical operation under benign conditions and opening pathways in low-energy nuclear processes.

### BACKGROUND OF THE INVENTION

### Field of the Invention

The present invention relates to the fields of electrochemistry and energy storage, and more particularly to systems and methods for electrochemical energy conversion in aqueous environments under ambient or near-ambient conditions, without reliance on chemical additives, catalysts, or elevated energy inputs.

### Description of the Related Art

Electrochemical energy storage systems, including batteries and fuel cells, are foundational technologies across a range of applications—from portable electronics to grid—scale power. These systems operate through ionic transport in an electrolyte and redox reactions at the electrodes. Conventional implementations often require chemically enriched electrolytes, thermal management systems, or catalytic components to meet performance requirements for energy density, voltage, and cycle life.

Aqueous electrochemical systems offer advantages in environmental safety and cost, but are fundamentally constrained by the low conductivity of pure water and its limited electrochemical stability window under ambient conditions. As a result, practical implementations typically introduce acids, bases, or salts to improve conductivity, which in turn increases system complexity and introduces corrosion and degradation risks over time.

Hydrogen-based energy systems, such as proton exchange membrane (PEM) fuel cells, are also well developed but require compressed hydrogen gas, precious-metal catalysts, and membrane assemblies. These dependencies demand controlled environments, specialized infrastructure, and raise safety and logistical barriers to widespread deployment.

Other research has explored hydrogen and deuterium species in electrochemical and solid-state systems, including investigations into anomalous energy phenomena. However, these approaches often rely on elevated temperatures, vacuum systems, or high-energy input conditions, and results have proven difficult to replicate consistently.

Accordingly, there remains a need for an electrochemical energy system that operates under ambient conditions without chemical doping, thermal input, or reliance on exotic apparatus. A system of this type would offer advantages in simplicity, sustainability, and materials compatibility, and may also open new pathways to underexplored electrochemical mechanisms.

### Comparison to Related Art

Prior work in aqueous electrochemical systems has explored various strategies for enabling energy storage in water-based environments. For example, U.S. Pat. No. 11,038,197 B2 describes a “water-in-salt” electrolyte architecture in which highly concentrated lithium salt solutions extend the electrochemical stability window of water to permit rechargeable operation. While effective, this approach requires significant ionic loading and chemically alters the aqueous medium, thereby introducing complexity and long-term corrosion risks.

Other hydrogen-based rechargeable systems, such as that disclosed in U.S. Pat. No. 5,712,054, utilize hydrogen evolution and recombination within structured electrode assemblies, but rely on the presence of liquid electrolytes and conventional redox chemistries. Similarly, Japanese Patent No. JP-7097700-B2 discloses hydrogen storage electrodes based on Group IV elements like silicon, but again depends on defined electrolyte formulations and bulk hydrogen absorption, diverging from surface-driven processes in chemically neutral media.

Academic research has also examined aqueous systems that avoid conventional additives. One notable example is Li et al. (Nature Communications, 2024), which reports spontaneous intercalation of hydronium ions (H₃O⁺) into tailored electrode materials immersed in ultra-pure water, supporting transient electrochemical behavior. However, that system lacks rechargeability and relies on specialized electrode chemistries that are not broadly generalizable or externally reactivated.

While these systems have advanced the use of water-based media in energy storage, they remain constrained by requirements for added electrolytes, complex material formulations, or narrowly tailored intercalation mechanisms. Accordingly, there remains a need for a rechargeable electrochemical system that operates in ultra-pure water under ambient conditions, without added electrolyte, catalytic media, or permanent chemical modification of the fluid medium.

### SUMMARY OF THE INVENTION

The present invention provides a rechargeable electrochemical energy system that operates entirely with ultra-pure water and specially preconditioned electrodes, without the need for added salts, acids, bases, or catalysts. At the core of this system is a process that transforms water from a poor electrical conductor into a functional electrolyte solely through surface-mediated interactions between the water and an infused electrode.

The system is initiated by embedding reactive hydrogen species—most notably atomic hydrogen—into the surface of a conductive electrode material such as aluminum or stainless steel. This infusion may be accomplished through multiple methods, including traditional electrolysis, thermal hydrogen exposure, or novel ambient-compatible techniques such as high-velocity water jet impingement. These processes modify the surface chemistry of the electrode, enabling it to release energetic partials that condition the surrounding water upon immersion.

Once submerged in ultra-pure water and paired with a second electrode, the infused electrode spontaneously generates an electrochemical potential. The water becomes weakly alkaline, as confirmed by diagnostic pH shifts, and functions as an electrolyte. A measurable voltage arises across the electrodes, enabling current flow without external electrolyte additives.

Crucially, the system exhibits rechargeable behavior: the infused electrode, once depleted, can be restored to its initial electrochemical state by reapplying an external potential, thus enabling repeated charge-discharge cycles. Experimental demonstrations have shown stable performance over multiple cycles, with voltages sufficient to power devices.

This system offers a simple, scalable, and environmentally benign alternative to conventional aqueous or hydrogen-based energy systems. It eliminates the need for chemical enrichment, exotic materials, or elevated operating conditions, while enabling new modes of electrochemical activity—and, in some configurations, supporting exploration of nuclear-coupled phenomena under ambient conditions.

### BRIEF DESCRIPTION OF THE DRAWINGS

FIG. 1 is a schematic diagram of an all-water electrochemical cell, showing a hydrogen-infused cathode, a non-infused anode, and an ultra-pure water medium. A voltmeter is connected across the electrodes to illustrate electrical output.

FIG. 2 is a functional flow diagram of the rechargeable battery cycle, depicting the sequence of electrode infusion, immersion in water, spontaneous voltage generation, discharge, and reactivation through re-infusion or electrical recharging.

### DETAILED DESCRIPTION OF THE INVENTION

The present invention provides a rechargeable electrochemical cell that operates using ultra-pure water and at least one specially prepared electrode, without the need for added electrolytes, acids, bases, or catalytic agents.

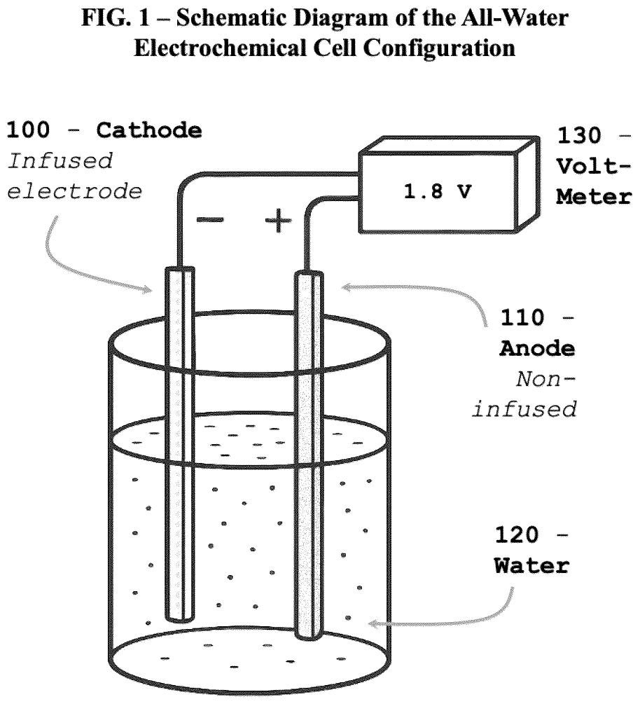

As shown in FIG. 1, a central feature of the invention is the transformation of ultra-pure water (120)—ordinarily a poor electrical conductor—into a functional electrolyte through interfacial interaction with a hydrogen-infused electrode (100). Once initiated, the system exhibits electrochemical activity sufficient to generate voltage and current under ambient conditions. The hydrogen-infused electrode (100) functions as the cathode, while a non-infused counter-electrode (110) acts as the anode. Electrical output is measured between the electrodes using a voltmeter (130) or an external load. The system can be restored to its initial operating condition through reinfusion of reactive hydrogen, enabling repeatable cycling.

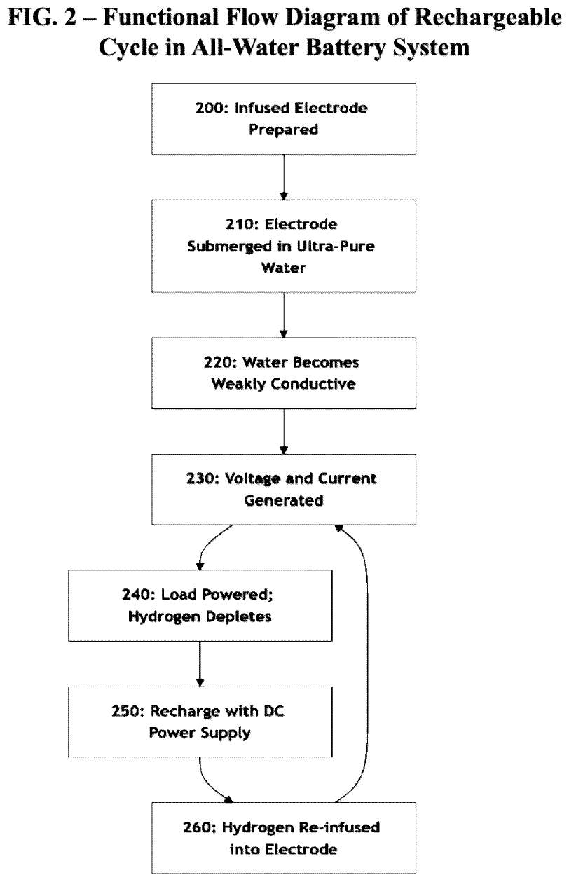

Referring to FIG. 2, step (200), the process begins with a preconditioning phase in which reactive hydrogen species—particularly atomic hydrogen—are embedded into the surface or near-surface region of a conductive solid material. This infusion may be achieved by various methods, including but not limited to: (i) electrolysis at a cathodic surface, where atomic hydrogen is formed via bubble bursting and interfacial reaction; (ii) exposure to a hydrogen-rich gaseous environment under elevated temperature; or (iii) bombardment with hydrogen ions or plasma species.

In addition to these established techniques, the invention introduces a novel, ambient-compatible infusion method based on high-velocity water jet impact. In this configuration, a narrow stream of water—such as from a dental irrigator—is directed at the target surface, creating localized regions of high shear and transient energy density. These microenvironments are believed to cause dissociation of water molecules, generating reactive hydrogen species that chemically or physically embed within the electrode surface.

Following infusion, the treated electrode is submerged in ultra-pure water (120) under ambient conditions, as shown in FIG. 2, steps (210) and (220). Interfacial reactions between the electrode (100) and the surrounding water alter the water's conductivity. Although ultra-pure water normally has very low ionic content, surface interactions release or activate hydrogen-derived species that locally generate hydroxide ions (OH⁻), resulting in a measurable increase in pH. This transformation renders the water weakly conductive and capable of supporting electrochemical reactions. This effect has been confirmed by pH indicator strips placed near the electrode, which shift toward alkaline coloration.

Once the water is activated, a spontaneous electrochemical potential develops between the infused cathode (100) and the counter-electrode (110), as indicated in FIG. 2, step (230). A measurable voltage appears across the terminals, and current can be drawn through an external circuit. The system produces sufficient electrical output to power devices, and it functions as a rechargeable battery without relying on added salts, acids, or catalysts.

After discharge, the electrode's reactive capacity may be restored by reapplying any of the infusion methods described above, including water jet impingement or electrolysis. These methods are performed under ambient conditions and require no thermal input or chemical additives. This regenerative capability allows the system to operate cyclically as a rechargeable battery, forming a closed-loop energy platform.

In some embodiments, reconditioning may alternatively be achieved by applying an external electrical potential—such as from a DC power supply—to reintroduce hydrogen species into the electrode. This approach may be used in hybrid energy systems or during scheduled maintenance cycles. As shown in FIG. 2, steps (250) and (260), either reactivation method reliably restores the original voltage and current output, enabling sustained operation of the rechargeable battery system.

Experimental validation confirms the functionality of the system across different material configurations. In one embodiment, aluminum electrodes infused via electrolysis produced an open-circuit voltage of approximately 0.309 volts. The voltage gradually declined as reactive hydrogen species were depleted but returned to its initial value after recharging, demonstrating repeatable electrochemical behavior.

In another embodiment using stainless steel electrodes, a single cell generated approximately 1.8 volts—sufficient to power a light-emitting diode (LED) for several minutes. Two cells connected in series yielded approximately 3.6 volts, confirming the system's scalability and compatibility with commonly used electronic components. These results demonstrate that the rechargeable battery system can deliver usable power under ambient, chemically neutral conditions.

Additional materials and configurations may be used to expand or refine the system. For example, non-conductive substrates such as glass, sapphire, or silicon oxide may be exposed to the same infusion techniques. Although these materials do not conduct electricity, their temporary exposure during the preconditioning phase assist in activating the surrounding water. Once activated, the system continues to operate with standard conductive electrodes alone.

In another variation, ultra-pure water may be substituted with heavy water (D₂O), allowing the infusion of deuterons rather than protons. While the core electrochemical functionality remains the same, this configuration presents opportunities for studying low-energy nuclear reaction (LENR) phenomena under benign conditions. These nuclear-level effects are speculative and not required for normal battery operation but may offer new directions for experimental research.

This system departs from traditional electrochemical and hydrogen-based energy technologies by enabling a fully rechargeable battery that functions without added electrolytes, catalysts, or elevated temperatures. It achieves persistent redox activity through surface-mediated activation of water using a hydrogen-infused electrode prepared by simple, accessible methods under ambient conditions. The ability to restore electrochemical performance across multiple cycles—without degradation or chemical buildup—positions this platform as a low-complexity, sustainable alternative to conventional batteries and fuel cells.

Furthermore, the compatibility of this system with a variety of infusion techniques, materials, and even isotopic variants like deuterated water opens new frontiers in clean energy storage, environmental electrochemistry, and experimental physics. These characteristics collectively distinguish the invention in both conceptual foundation and practical application from any known aqueous or hydrogen-based energy system.

### DEFINITION OF TERMS

Infused Electrode—A conductive material that has been pretreated to incorporate reactive hydrogen species—such as atomic hydrogen—into its surface or subsurface regions. This infusion modifies the electrode's electrochemical properties and enables activation of water as an electrolyte when submerged.

Reactive Hydrogen Species—Chemically active forms of hydrogen, including atomic hydrogen (H·), hydride ions (H⁻), or protonic hydrogen (H⁺), which are capable of interacting with electrode materials or water molecules to initiate redox reactions.

Ultra-Pure Water—Water that contains minimal dissolved ions, organics, or particulates, typically with a resistivity of 18.2 MΩ·cm or greater. In the context of this invention, ultra-pure water serves as the initial, non-conductive reaction medium.

Electrochemical Cell—A system comprising two electrodes immersed in a medium capable of sustaining ionic conductivity, such that electrical energy may be generated or stored through redox reactions at the electrode interfaces.

Jet Impingement (Water Jet Infusion)—A surface treatment method in which a high-velocity stream of water is directed at a target material under ambient conditions, resulting in localized energy transfer sufficient to promote chemical modification or hydrogen incorporation.

Electrolysis (for Infusion)—A process by which electrical current is passed through an electrolyte to drive a non-spontaneous reaction. In the context of infusion, electrolysis generates atomic hydrogen at a cathode, some of which is absorbed into the electrode.

Surface-Mediated Water Activation—A phenomenon in which the chemical or physical properties of an electrode surface induce a transformation of ultra-pure water from a non-conductive to a weakly conductive state, enabling electrochemical function without added solutes.

Hydroxide Ion (OH⁻)—A negatively charged ion formed when a hydrogen atom is removed from a water molecule. Its appearance in solution indicates an increase in pH and is used as evidence of electrochemical activity in the present invention.

Recharging (Electrochemical Restoration)—The process of restoring reactive hydrogen species to an electrode after discharge by applying an external electrical potential, thereby re-enabling the electrochemical function of the system.

Low-Energy Nuclear Reactions (LENR)—Hypothetical nuclear processes that may occur at or near room temperature, potentially involving deuterium or hydrogen absorbed into solid materials. While not essential to the invention, the architecture described may facilitate related investigations.

Open-Circuit Voltage—The electrical potential difference between two electrodes in a cell measured without a connected load. Used to assess the electrochemical readiness or performance of the system after activation.

Spontaneous Electrochemical Potential—A naturally arising voltage between two electrodes in the absence of externally applied power, resulting from internal redox gradients or surface-driven charge separation within the system.

What is claimed is:

1. A rechargeable electrochemical system comprising:
a container containing ultra-pure water;
a first electrode infused with reactive hydrogen species;
a second electrode not infused with reactive hydrogen species;
wherein the first and second electrodes are both submerged in the ultra-pure water under ambient conditions;
wherein, upon immersion, the water becomes electrically conductive and an electrochemical potential is spontaneously generated between the electrodes;
and wherein the system is operable in repeated charge-discharge cycles by restoring reactive hydrogen species to the first electrode.

2. The system of claim 1, wherein the reactive hydrogen species comprise atomic hydrogen.

3. The system of claim 1, wherein the first electrode comprises a conductive material capable of absorbing and releasing reactive hydrogen species under ambient conditions.

4. The system of claim 3, wherein the conductive material comprises a metal, alloy, conductive polymer, or other solid conductive material having affinity for hydrogen species.

5. The system of claim 1, wherein the reactive hydrogen species are infused into the first electrode by electrolysis.

6. The system of claim 1, wherein the reactive hydrogen species are infused into the first electrode by high-velocity water jet impingement.

7. The system of claim 1, wherein the reactive hydrogen species are infused into the first electrode by exposure to a hydrogen-containing atmosphere under elevated temperature.

8. The system of claim 1, wherein the first electrode is recharged by repeating the infusion process.

9. The system of claim 1, wherein the first electrode is recharged by applying a direct current electrical potential across the electrodes.

10. The system of claim 1, wherein a plurality of electrochemical cells are electrically connected to increase total voltage, current, or capacity.

11. The system of claim 1, wherein the ultra-pure water is substituted with heavy water (D₂O).

12. The system of claim 1, wherein the ultra-pure water remains free of added electrolyte, salt, acid, or base throughout all charge-discharge cycles.

13. A method for producing a rechargeable electrochemical cell, comprising:
infusing reactive hydrogen species into a first electrode;
submerging the first electrode and a second electrode into ultra-pure water under ambient conditions;
generating an electrochemical potential between the electrodes without added electrolytes, catalysts, or thermal energy;
and recharging the first electrode following discharge by repeating the infusion step or applying an external electrical potential.

14. The method of claim 13, wherein the infusion step comprises exposing the first electrode to a hydrogen-containing gas under elevated temperature.

15. The method of claim 13, wherein the infusion step comprises directing a high-velocity stream of water at the first electrode under ambient conditions.
